(19) United States
(12) Patent Application Publication
(10) Pub. No.: US 2020/0219138 A1
(43) Pub. Date: Jul. 9, 2020

(54) CUSTOMIZED CUSTOMER SALES DESIGN METHOD

(71) Applicant: Chad Groves, Wilmington, DE (US)

(72) Inventor: Chad Groves, Wilmington, DE (US)

(21) Appl. No.: 16/736,245

(22) Filed: Jan. 7, 2020

Related U.S. Application Data
(60) Provisional application No. 62/789,079, filed on Jan. 7, 2019.

(51) Int. Cl. G06Q 30/02; G06Q 30/00; G06Q 30/06

(52) U.S. Cl. CPC G06Q 30/0269; G06Q 30/01; G06Q 30/0267; G06Q 30/0623; G06Q 30/0631; G06Q 30/0641; G06Q 30/0277

(57) ABSTRACT

A computer-based customer preference system enables a merchant to prepare a customized, and in some cases an individualized, customer sales design that is based on inputs to the system. A plurality of inputs may be used to determine what products or set of products and styles a customer may prefer. A customized customer sales design can then be prepared for the customer or set of customers, which may result in higher sales. The input to the computer-based customer preference system may include a customer profile input, a showroom preference input, an electronic advertisement link preference input, and a website preference input. These pluralities of inputs may be utilized by a computer program to tabulate and recommend display products for use in a customized customer sales design. A showroom preference input may include dwell time at a display, a preference input to a mobile device or input link.

### CROSS-REFERENCE TO RELATED APPLICATIONS

This application claims the benefit of priority to U.S. Provisional Patent Application No. 62/789,079, filed on Jan. 7, 2019, the disclosure of which is incorporated by reference herein in its entirety.

### FIELD OF THE INVENTION

This application is directed to a customized customer sales design method that utilizes a plurality of customer inputs to determine a product or set of products that can be configured as a customized customer sales design.

### BACKGROUND

Selling products to customers is becoming increasingly individualized. Customers want to see specific products that appeal to their unique tastes. Determining what product or products the customer may prefer is challenging and a learning process. If a customer feels that the selection of products offered by a place of business is not their style, they may move on to another establishment. High-end retailers make great efforts to appeal to a customer's specific tastes but the process to determine what the customer prefers can sometimes take too long, thereby resulting in loss of sales.

### SUMMARY OF THE INVENTION

The invention is directed to a method of preparing a customized, and in some cases an individualized customer sales design. The method utilizes a computer-based customer preference system that receives a plurality of inputs that are used to determine what products or set of products and styles a customer may prefer. A customized customer sales design can then be prepared for the customer, or set of customers, which may result in higher sales. The input to the computer-based customer preference system may include a customer profile input, a showroom preference input, an electronic advertisement link preference input, and a website preference input. These inputs may be utilized by a computer program to tabulate and recommend display products for use in a customized customer sales design. A sales associate may then prepare a customized customer sales design utilizing products recommended by the computer-based customer preference system that is more likely to result in a sale.

The computer program used in the method of preparing an individualized customer sales design may incorporate an algorithm to indicate a product that had the highest number of inputs from said plurality of inputs. This higher number of inputs is more likely to be a product or display that the customer will prefer. The number of inputs may include the amount of time a customer spends at a customer sales display, the number of website or electronic advertisement inputs, as well as any customer profile inputs. As describe herein, a customer may provide a profile that includes contact information, budget for a product, and some initial customer preference of products or styles. This initial customer preference may be an input that is added to the other inputs to provide a ranking of preferred products. Products with the most inputs may be determined by the algorithm to be the most preferred products. The customer profile may be filled out by the customer, and then later input into the computer-based customer preference system by an associate of the business establishment. In an alternate embodiment, a customer may fill in the information directly into the computer-based customer preference system and the system may request some initial input on types of products preferred. A product or customer sales design may be shown on the computer display and the customer may provide a preference. They may simply give a thumbs up or down to the product, or may provide a ranking or numeric score for the product, e.g., 10 being highly preferred and 1 being not preferred. If the customer gives a thumbs up, this may be considered a preferable input to the system and if the customer provides a numeric score above a threshold, such as above 7 or 8 on a scale of 10 for example, this may be considered a preferable input for the system. In another embodiment, the computer-based customer preference system may display two or more products or customer sales designs and the customer may select which one they prefer between the pair. Again, preferring on product or design over another may be considered a preferable input to the system for tabulation by the algorithm.

An exemplary method of preparing a customized customer sales design includes the input of a showroom preference input to the computer-based customer preference system. A customer may walk through a showroom having a plurality of products or customer sales designs displayed in the showroom, and a sensor may monitor the location of the customer to determine how long, a “dwell time,” they spend at various displays looking at various products. The sensors may be heat or thermal sensors, such as infrared cameras, or motion detection sensors that detect when a customer is in a particular area of the showroom and viewing a particular display. The sensor may be a video camera and the time may be input manually. The customer may have a wireless interface such as a mobile phone or a device provided by a sales associate, and this wireless interface may communicate with one or more sensors via Bluetooth to automatically record the dwell time spent viewing a product or display. A plurality of sensors is located around the showroom and may automatically detect when the customer is proximal to a sensor and begin a counter, or measure the time until they move away from the product or display. When a customer spends more than a threshold period of time at a display, the product or products in the display may be considered preferable products and this may result in an automatic or manual input for the products in the display for tabulation by the algorithm. The time spent at a display may be ranked versus time spent at other displays to provide a ranking for a product or products in a display based on the comparison of time spent. This ranking may then be used as an input value that can be summed with any other inputs from the customer or customers.

In an exemplary embodiment, a customer has a mobile electronic device, such as a mobile phone or tablet computer having a wireless signal transceiver. As the customer walks through the showroom, the time spent at various displays or in various areas of the showroom are monitored and recorded by the computing system. The computer-based customer preference system may utilize a global positioning system to determine the location of the customer and record the time spent at each display, and this recorded time may be a preference input that is used in the computer program of the computer-based customer preference system to determine what product or products to include in a customized customer sales design. In addition, the computer-based customer preference system may send an electronic advertisement, pop-up ad, as the customer is moving through the showroom. The pop-up ad may show the items in the display that the customer is currently viewing. The pop-up ad may ask the customer for an input, such as input link to learn more about the product, products in the display and the like. In addition, the computer-based customer preference system may send a pop-up ad that requests a preference input, such as ranking the customer's preference of the product or display. When a customer click on a pop-up add for a product or grouping of products, each product may be considered preferable and this may be an input to the system. The preference input may be a numerical input, such as a low number for non-preference and a higher number for preference.

An exemplary method of preparing a customized customer sales design includes the input of an electronic advertisement link preference input to the computer-based customer preference system. A customer may view ads sent to them having a display of a product or customer sales display, and when the customer clicks on the image or on an input button, the input is recorded in the computer-based customer preference system and may be considered a preferable input by the system. The URL location of the customer may be tracked and used to identify the customer input.

An exemplary method of preparing a customized customer sales design includes the input of an electronic website link preference input to the computer-based customer preference system. A customer may view a display of a product or customer sales display on the website and when the customer clicks on the image or on an input button, the input is recorded in the computer-based customer preference system. The customer may login to the website and their subsequent inputs may then be attributed to that specific customer. A website may request input on products and have a ranking or score input feature. As described herein, two or more products or displays may be shown and a request that the customer make a preference between the two may be provided.

The summary of the invention is provided as a general introduction to some of the embodiments of the invention, and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a customized customer sales design having a plurality of products.

FIG. 2 shows a computing system used to input a customer profile input.

FIG. 3 shows a computing system used to input a customer profile input.

FIG. 4 shows an exemplary showroom having a plurality of customer sales designs, wherein at least some may be customized sales designs.

FIG. 5 shows an exemplary display having a plurality of products and a mobile electronic device being utilized by a customer to provide a preference input to the computer-based customer preference system.

FIG. 6 shows a computing system used to input a website preference input.

FIG. 7 shows a computing system used to input an advertisement link preference input.

Corresponding reference characters indicate corresponding parts throughout the several views of the figures. The figures represent an illustration of some of the embodiments of the present invention and are not to be construed as limiting the scope of the invention in any manner. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

Definitions:

A showroom may be an open space for the display of products, such as a parking lot for a plurality of vehicles, or may be in a building, such as a showroom floor within a furniture store. A display on the showroom floor may be a single product or a plurality of products, such as in a furniture store display.

A merchant may have a place of business having a physical showroom with a plurality of products displayed, or may be an on-line merchant with a plurality of products displayed on an electronic display of an electronic device individually or in a virtual showroom.

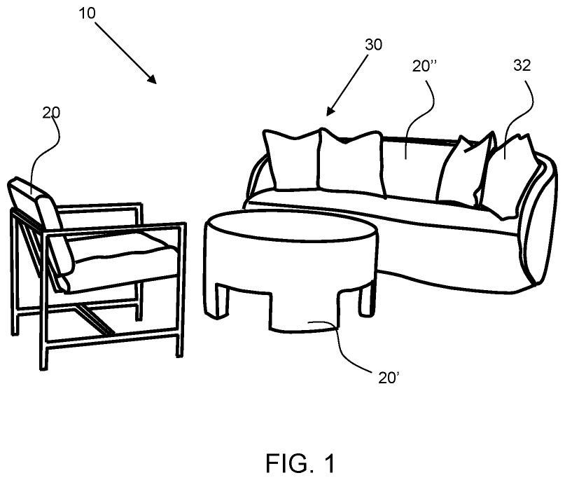

As shown in FIG. 1, an exemplary customized customer sales design 10 is a customer display 32 that has a plurality of products 20-20″, selected and arranged as determined by the method of preparing a customized customer sales design, as described herein. The products and the color, or fabric of the products, may be determined from the plurality of inputs to the computer-based customer preference system. The customized customer sales design may be for an individual customer or for a group of customers, wherein input from a plurality of customers is used to select the products used in the display.

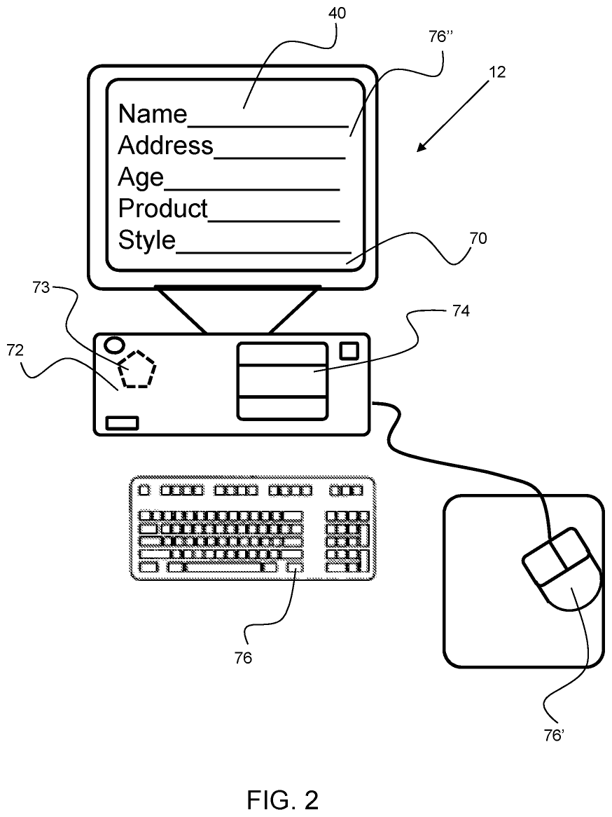

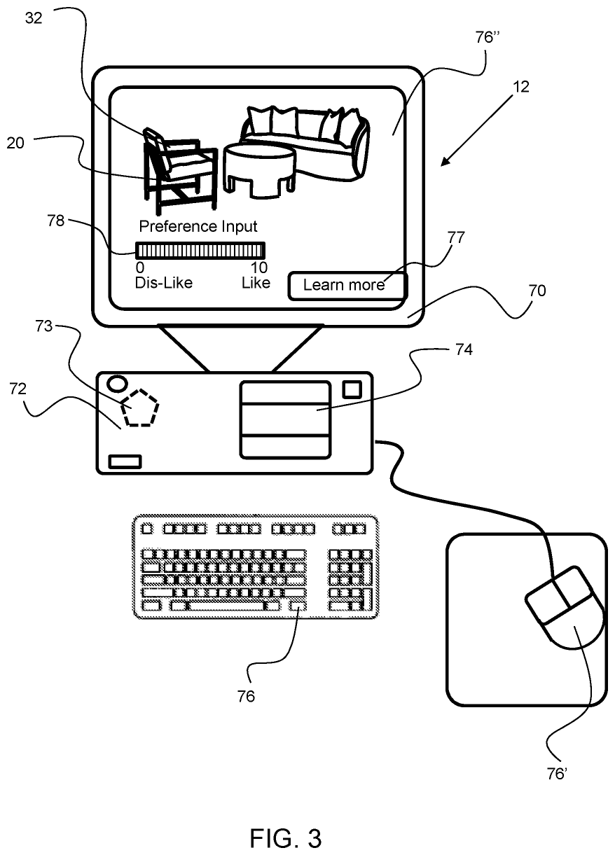

Referring to FIGS. 2 and 3, a computing system 70 is used to input a customer profile input 40 into the computer-based customer preference system 12. The computer-based customer preference system comprises a computer program 74 operated by the computing device 72, and a microprocessor 73 thereof. A user may input customer profile input, such as name, address, age, etc. The customer may input this information or may provide this information and a sales associate may input the information. A user may utilize a user interface 76-76″ to input information, such as a keyboard 76, mouse 76′, or touch-screen 76″ for example. As shown in FIG. 3, a customer or sales associate may input preferences of products as a customer profile input. As shown, a preference input 78, such as a ranking or preference scale, input may be entered into the computer-based customer preference system 12 for a display of a particular product 20 or a customer display 32. An input link may also be provided to the customer on the display 75 of the computing system 70 and if the customer clicks on this link to “Learn More,” for example, this may be used by the computer-based customer preference system as a preference input by the customer. The computer program may include an algorithm for determining or tabulating a product or products having the highest number of inputs from a plurality of inputs, as described herein. The algorithm may sum a preference input, ranks, time spent at a display and the like to tabulate and determine a product that the customer may prefer.

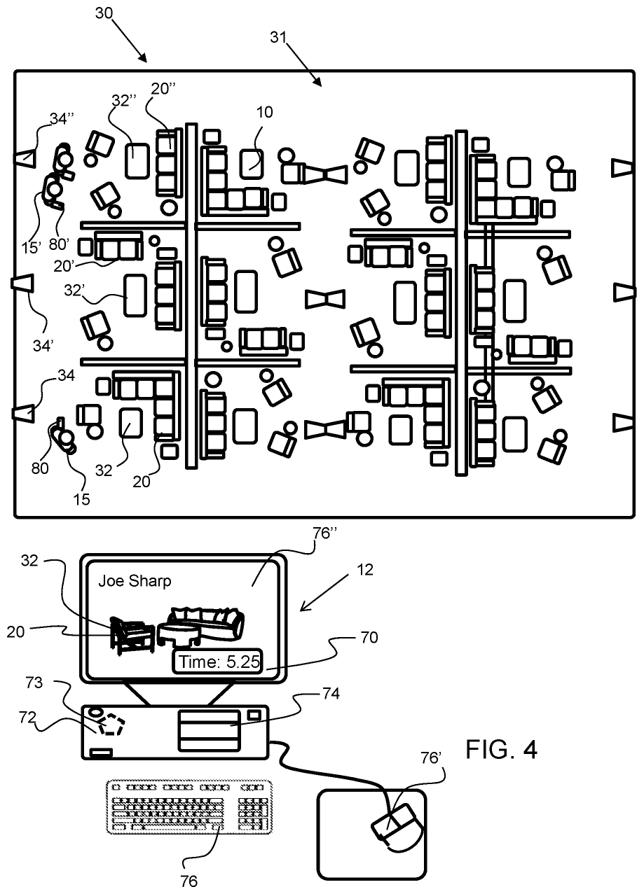

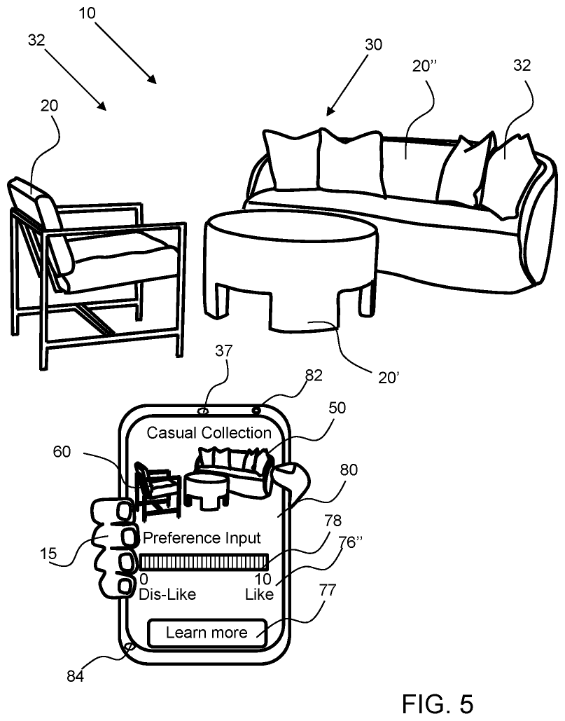

Referring now to FIGS. 4 and 5, a showroom 30 of a merchant 31 may have a plurality of customer sales displays 32, and at least some may be customized sales designs 10. A customer 15, 15′ may move through the showroom looking at various customer sales displays, and a sensor 34 may monitor the location of a customer. Again, the sensor may be a motion sensor, or a heat or infrared sensor, such as a camera, or a video camera. The amount of time a customer spends at a particular customer sales display may be recorded into the computer-based customer preference system 12. This input to the computer-based customer preference system may be used to determine customer preferences, as the more time the customer spends viewing a particular customer sales display, the more likely they are to prefer this type of design, or products used therein. The customer may carry a wireless interface 37, such as a mobile electronic device 80, a mobile phone for example, that records when they are viewing a customer sales display 32. The wireless interface may be a Bluetooth interface with the sensor 34, or the computer-based customer preference system 12 may utilize global positioning system, GPS 84, to determine the location of the customer within the showroom and to determine how much time they spend at each display. This time can be recorded and used by the computer-based customer preference system as a preference input. As shown in FIG. 5, the computer-based customer preference system may send an advertisement, such as a pop-up ad, that is related to the display or area of the showroom in which the customer is currently located. The pop-up add may request a preference input 78 of the display or products and/or may provide an input link 77. The wireless transceiver 82 of the mobile device 80 may communicate with the computer-based customer preference system to provide preference inputs. Note that the preference input 78 and/or input links 77 may be specifically designed for in store input and may be different from an advertisement link preference input that is displayed or utilized when a customer is not located in the store or in the showroom.

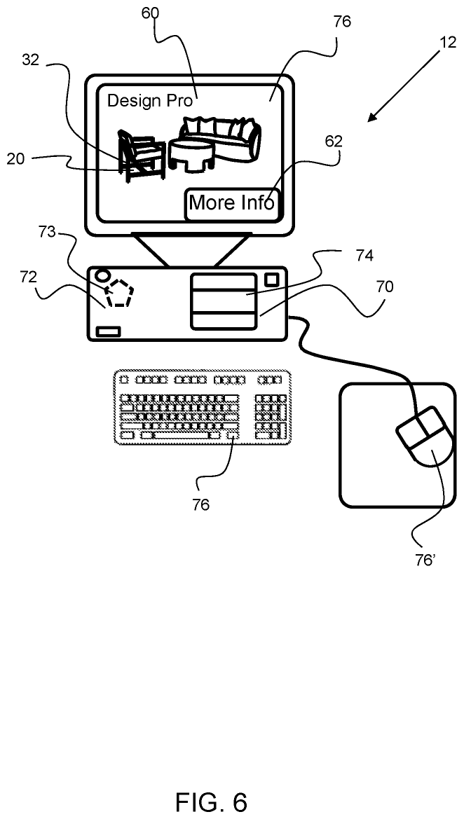

As shown in FIG. 6, an input to the computer-based customer preference system 12 may be a website preference input 62. A customer may be viewing the website 60 and may click on an input, such as requesting more information about a product or display, and this user interface with the website may be input to the computer-based customer preference system.

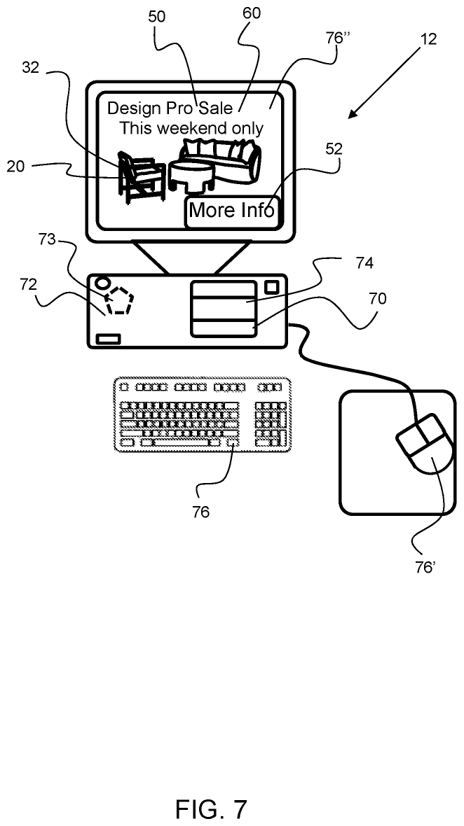

As shown in FIG. 7, an input to the computer-based customer preference system 12 may be an advertisement link preference input 52. A customer may be viewing an electronic advertisement 50 and may click on an input, such as requesting more information about a product or display, and this user interface with the electronic advertisement may be input to the computer-based customer preference system.

It is to be understood that this method may be used to prepare a customize customer sales design for an individual customer or for a plurality of customers. The input from an individual customer may be used by the computer-based customer preference system to determine what products to include in the display, or the input from a group of customers may be used. The subset of customers may be determined through a geographical region, for example, and the store location in that area may have customer sales displays that correlate with the preferences of the customers living in that area.

The product or customer sales design may include any suitable product, including furniture, artwork, electronics, vehicles, home decor, and the like. In an exemplary embodiment, the products are furniture and the customer sales design includes a set of furniture, and in some cases accessories, including lamps, rugs, carpet, sculptures, wall hangings, art, paintings, and the like.

It will be apparent to those skilled in the art that various modifications, combinations and variations can be made in the present invention without departing from the spirit or scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A method of preparing an individualized customer sales design comprising:
a) providing a plurality of products;
b) providing a computer-based customer preference system that receives a plurality of inputs, comprising:
i) a customer profile input; and one or more of
ii) a showroom preference input;
iii) an electronic advertisement link preference input; and
iv) a website preference input;
c) tabulating said input to determine a product preference from said plurality of products; and
d) preparing said individualized customer sales design comprising said product preference.

2. The method of preparing an individualized customer sales design of claim 1, wherein tabulating said input to determine a product preference from said plurality of products comprises an algorithm to indicate a product that had the highest number of inputs from said plurality of inputs.

3. The method of preparing an individualized customer sales design of claim 1, wherein the input provided to the computer-based customer preference system includes a showroom preference input.

4. The method of preparing an individualized customer sales design of claim 1, further providing a showroom and wherein the plurality of products are displayed in said showroom, and wherein the input provided to the computer-based customer preference system includes a showroom preference input.

5. The method of preparing an individualized customer sales design of claim 4, wherein the showroom preference input includes a dwell time, wherein the dwell time is an amount of time a customer spends viewing a product located in the showroom.

6. The method of preparing an individualized customer sales design of claim 5, further providing a dwell time sensor located in the showroom, and wherein the dwell time is determined by an input from the dwell time sensor.

7. The method of preparing an individualized customer sales design of claim 5, wherein the dwell time sensor is a motion sensor.

8. The method of preparing an individualized customer sales design of claim 5, wherein the dwell time sensor is a thermal camera.

9. The method of preparing an individualized customer sales design of claim 5, further comprising a mobile electronic device having a global positioning sensor, and wherein the dwell time is determined by the computer-based customer preference system by tracking the location of the mobile electronic device within the showroom.

10. The method of preparing an individualized customer sales design of claim 5, wherein the showroom comprises a plurality of displays, each having one or more of said plurality of products; and
wherein the showroom input comprises said dwell time at said display.

11. The method of preparing an individualized customer sales design of claim 4, further comprising a mobile electronic device, and wherein the showroom preference input is a preference input provided by said customer through the mobile electronic device while in the showroom.

12. The method of preparing an individualized customer sales design of claim 4, further comprising a mobile electronic device, and wherein the showroom preference input is an input link provided by said customer through the mobile electronic device while in the showroom.

13. The method of preparing an individualized customer sales design of claim 1, wherein the input provided to the computer-based customer preference system includes two or more of:
i) a showroom preference input;
ii) an electronic advertisement link preference input; and
iii) a website preference input.

14. The method of preparing an individualized customer sales design of claim 1, wherein the input provided to the computer-based customer preference system includes all three of:
i) a showroom preference input;
ii) an electronic advertisement link preference input; and
iii) a website preference input.

15. The method of preparing an individualized customer sales design of claim 1, wherein the plurality of products are physical products.

16. The method of preparing an individualized customer sales design of claim 1, wherein the plurality of products are furniture, wherein the showroom is a furniture showroom, and wherein the individualized customer sales design comprises two or more pieces of furniture.

17. The method of preparing an individualized customer sales design of claim 1, wherein the customer profile data comprises age, race, income, style preferences, color preferences, home location, and budget.

18. The method of preparing an individualized customer sales design of claim 1, wherein the electronic advertisement link preference input includes a customer click on a plurality of electronic advertisements having one or more of said plurality of products displayed thereon.

19. The method of preparing an individualized customer sales design of claim 1, wherein the electronic advertisement link preference input includes a customer click on an electronic advertisement having one or more of said plurality of products displayed thereon.

20. The method of preparing an individualized customer sales design of claim 1, wherein the website preference input includes a customer click on a product displayed on a website.

21. The method of preparing an individualized customer sales design of claim 1, wherein tabulating said input to determine a product preference from said plurality of products comprises an algorithm to indicate a product that had the highest number of inputs from said plurality of inputs, and wherein said plurality of inputs is from a plurality of customers.

22. The method of preparing an individualized customer sales design of claim 21, wherein the highest number of inputs is determined from a total number of inputs from a plurality of customer inputs.

23. The method of preparing an individualized customer sales design of claim 21, wherein the showroom comprises a plurality of displays, each having one or more of said plurality of products;
further comprising a showroom sensor that is configured to measure a dwell time of a plurality of customers at a display; and
wherein the showroom input comprises said dwell time at said display.

24. The method of preparing an individualized customer sales design of claim 23, wherein the plurality of customer inputs includes a plurality of:
i) customer profile input; and one or more of
ii) a showroom preference input;
iii) an electronic advertisement link preference input; and
iv) a website preference input.

25. The method of preparing an individualized customer sales design of claim 24, wherein the plurality of customer inputs includes a plurality of showroom preference inputs from a plurality of customers.

26. The method of preparing an individualized customer sales design of claim 24, wherein the plurality of customer inputs includes two or more of:
i) a showroom preference input;
ii) an electronic advertisement link preference input; and
iii) a website preference input.

27. The method of preparing an individualized customer sales design of claim 24, wherein the plurality of customer inputs includes all three of:
i) a showroom preference input;
ii) an electronic advertisement link preference input; and
iii) a website preference input.
